(19) United States
(12) Patent Application Publication
(10) Pub. No.: US 2026/0208978 A1
(43) Pub. Date: Jul. 23, 2026

(54) WORKPIECE TRANSFER DEVICE

(71) Applicant: GUYOUNG TECHNOLOGY CO., LTD., Daegu (KR)

(72) Inventor: HEE HWA LEE, Chilgok-gun (KR)

(21) Appl. No.: 19/369,369

(22) Filed: Oct. 27, 2025

(30) Foreign Application Priority Data
Jan. 23, 2025 (KR) 10-2025-0010190

(51) Int. Cl. B65G 47/91; B65G 13/11

(52) U.S. Cl. CPC B65G 47/915; B65G 13/11; B65G 2201/022

(57) ABSTRACT

Provided is a workpiece transfer device including: a transfer carrier having a bottom frame, side frames erected on both sides of the bottom frame, and a top frame located on tops of the side frames and having carrier hooks; bottom spacers located on the bottom frame and each having a plurality of bottom jig grooves adapted to receive the bottoms of workpieces therein, the workpieces being erectedly placed in the transfer carrier; and top spacers spaced apart from one another on the top frame in such a way as to correspond to the bottom jig grooves, movable in a longitudinal direction thereof, and each having a plurality of top jig grooves adapted to receive the tops of the workpieces therein.

### CROSS REFERENCE TO RELATED APPLICATION OF THE DISCLOSURE

The present application claims the benefit of Korean Patent Application No. 10-2025-0010190 filed in the Korean Intellectual Property Office on Jan. 23, 2025 the entire contents of which are incorporated herein by reference.

### BACKGROUND OF THE DISCLOSURE

### Field of the Disclosure

The present disclosure relates to a workpiece transfer device, more specifically to a workpiece transfer device that is structurally improved to allow top spacers to receive downward pressing forces from weights in a direction of gravity so that only through an upward motion of a robot arm, a distance between the top spacers and bottom spacers is expanded and contracted to clamp and unclamp a workpiece, thereby achieving automation in the processes of loading and unloading the workpiece in and from a transfer carrier by means of the robot arm.

### Background of the Related Art

Typically, a coating process is carried out to protect a material to be coated from various pollutants and substances causing corrosion and to increase the lifespan of the material to be coated, and in the case of parts in an electric field such as battery cases, the coating process is widely applied to form a coating layer on the battery case so that an insulation function is added to the battery case.

As an automated manufacturing line is provided, a variety of transfer facilities are developed and applied to industrial sites to supply materials to be coated and discharge the coated materials, but in the process of transferring the materials to be coated, typically, they are loaded on a cart to move to a given position and are then unloaded and loaded one by one manually.

A conventional technology as disclosed in Korean Patent No. 10-2123790 is provided with a pair of lifting devices that has an overall height higher than a bottom frame of a palette and an overall length greater than an overall width thereof, and the pair of lifting devices includes: a driving motor; a shaft connected to the driving motor and rotating in an axial direction; a coupling connected to the shaft; an up and down guide coupled to the coupling; a cam connected to the up and down guide; a lifting bar coupled to the cam and provided horizontally to the overall height; a front and back guide coupled to one side of the up and down guide; and a guide rail to which the front and back guide is connected to form a forward and backward moving path of the front and back guide and having an axis parallel to the shaft.

The conventional technology is an ultra-low floor type device passing through a space under the bottom frame of the palette (cart), thereby enhancing a degree of utilization of the internal space of a factory and minimizing the risk of overturning an Automated Guided Vehicle (AGV), but the conventional technology is configured to load one workpiece on the palette (cart) so that if a plurality of workpieces such as materials to be coated are loaded, they may be damaged due to collision and friction among the workpieces.

### PRIOR ART DOCUMENT

### Patent Document

(Patent document 0001) Korean Patent No. 10-2123790 B1

(Patent document 0002) Korean Patent No. 10-2587903 B1

### SUMMARY OF THE DISCLOSURE

Accordingly, the present disclosure has been made in view of the above-mentioned problems occurring in the related art, and it is an object of the present disclosure to provide a workpiece transfer device that is structurally improved to allow top spacers to receive downward pressing forces from weights in a direction of gravity so that only through an upward motion of a robot arm, a distance between the top spacers and bottom spacers is expanded and contracted to clamp and unclamp a workpiece, thereby achieving automation in the processes of loading and unloading the workpiece in and from a transfer carrier by means of the robot arm.

To accomplish the above-mentioned objects, according to the present disclosure, there is provided a workpiece transfer device including: a transfer carrier having a bottom frame, side frames erected on both sides of the bottom frame, and a top frame located on tops of the side frames and having carrier hooks; bottom spacers located on the bottom frame and each having a plurality of bottom jig grooves adapted to receive the undersides of workpieces therein, the workpieces being erectedly placed in the transfer carrier; and top spacers spaced apart from one another on the top frame in such a way as to correspond to the bottom jig grooves, movable in a longitudinal direction thereof, and each having a top jig groove adapted to receive the top of the corresponding workpiece therein.

According to the present disclosure, desirably, each top spacer may include sleeves mounted on the top frame, a rod inserted into the sleeves in such a way as to linearly move in a longitudinal direction, a top jaw located on the underside of the rod and having the top jig groove on the underside thereof, and a weight located on top of the rod in such a way as to press the rod downward.

According to the present disclosure, desirably, the bottom jig grooves and the top jig grooves may be V-shaped grooves, and if the workpieces are restrained by the top spacers and the bottom spacers, tops and undersides of the workpiece may be corrected in position to the centers of the V-shaped grooves as the bottom jig grooves and the top jig grooves.

According to the present disclosure, desirably, each top jig groove may have a grasping edge on the inner peripheral surface thereof in such a way as to grasp top of the workpiece and thus restrain the workpiece thereby.

According to the present disclosure, desirably, the workpiece placed in the transfer carrier may be clamped by a suction pad of a robot arm, and in a state where the suction pad of the robot arm is sucked onto one side surface of the workpiece, if the workpiece moves upward together with the top jaws by means of the robot arm, the underside of the workpiece may become separated from the bottom jig grooves and be then inclined at a given angle by means of the robot arm, so that the underside of the workpiece may be separated from the bottom jig grooves to the outside, and next, if the workpiece moves downward by means of the robot arm, the top of the workpiece may be separated from the top jig grooves to the outside to allow the workpiece to be unloaded from the transfer carrier.

According to the present disclosure, desirably, the workpiece may be clamped by the suction pad of the robot arm, and in the state where the suction pad of the robot arm is sucked onto one side surface of the workpiece, the workpiece may be inclined at a given angle, put between the top spacers and the bottom spacers, and moves upward together with the top jaws in a state where the top of the workpiece is received in the top jig grooves by means of the robot arm, so that if the workpiece is corrected perpendicularly in position and then moves downward by means of the robot arm, the underside of the workpiece may be received in the bottom jig grooves and restrained thereby.

According to the present disclosure, desirably, the rod or the top jaw may have a lift pin on one side thereof, and the robot arm may have a robot pushing piece at a position corresponding to the lift pin, so that to load the workpiece in the transfer carrier, if the workpiece is clamped by the robot arm, is inserted into the transfer carrier, and thus moves upward at a position corresponding to the top spacers and the bottom spacers, the lift pins may be pressed against the robot pushing pieces to allow the top jaws to move upward, which causes the top jig grooves and the workpiece to be kept separated from each other, and if the workpiece is corrected perpendicularly in position and then moves downward by means of the robot arm, next, the underside of the workpiece may be received in the bottom jig grooves to allow the upward pressing forces of the robot pushing pieces against the lift pins to be released, which causes the workpiece to be restrained by the top jig grooves through the downward movements of the top jaws.

According to the present disclosure, desirably, the transfer carrier may be lifted by means of a lifting loader, moves along a loading conveyor, and is transferred to a process line, and the lifting loader may include: a cart unit adapted to support the underside of the transfer carrier thereagainst and having a plurality of casters; a lift unit buried in a floor at the entrance of the loading conveyor in such a way as to lift the transfer carrier mounted onto the cart unit to allow the bottom frame of the transfer carrier to be placed on the same horizontal line as the loading conveyor; transfer rollers located on top of the lift unit in such a way as to support the underside of the transfer carrier mounted onto the cart unit; side rails located on the floor in such a way as to correspond to both sides of the lift unit in the transverse direction of the lift unit in such a way as to guide the cart unit to allow the cart unit to move to an area corresponding to top of the lift unit; and parking stoppers located on the floor in such a way as to restrict the moving distance of the cart unit moving to the lift unit along the side rails.

According to the present disclosure, desirably, the cart unit may consist of the casters, a pair of base arms having locking projections adapted to receive the underside of the transfer carrier therein, and transverse bars for connecting the pair of base arms to each other in such a way as to be received between the transfer rollers of the lift unit if the transfer carrier is lifted by means of the lift unit, and the lift unit may have stop grooves on top thereof in such a way as to allow the transverse bars received between the transfer rollers of the lift unit to be restrained thereby, so that if the transfer carrier is lifted by means of the lift unit, the transverse bars may be received in the stop grooves to allow the cart unit to be fixed in position, and the transfer carrier mounted onto the cart unit may be lifted in a state of being supported against the transfer rollers to allow the underside of the transfer carrier to be separated from the locking projections and then move to the loading conveyor along the transfer rollers.

According to the present disclosure, desirably, the loading conveyor may include: a roller conveyor having a plurality of first feeding rollers adapted to transfer the transfer carrier received from the lifting loader; a movable conveyor located on the end portion of the roller conveyor and having a plurality of second feeding rollers on top thereof to mount the transfer carrier thereon; and a transfer shuttle transferred to the process line along transfer rails, while supporting the movable conveyor to allow the movable conveyor to be movable up and down.

According to the present disclosure, desirably, the transfer carrier may be transferred along the first feeding rollers of the roller conveyor and then mounted on the movable conveyor along the second feeding rollers, so that if the transfer carrier moves to an area under a process conveyor of the process line, together with the movable carrier, by means of the transfer shuttle, the transfer carrier may move upward together with the movable conveyor by means of the transfer shuttle, and if the transfer carrier moves in the longitudinal direction of the process conveyor by means of the second feeding rollers, the carrier hooks mounted on top of the transfer carrier may be mounted on the process conveyor to allow the movable conveyor to move downward by means of the transfer shuttle and thus return to a position corresponding to the roller conveyor along the transfer rails.

### BRIEF DESCRIPTION OF THE DRAWINGS

The above and other objects, features and advantages of the present disclosure will be apparent from the following detailed description of the embodiments of the disclosure in conjunction with the accompanying drawings, in which:

FIG. 1 is a perspective view showing a transfer carrier of a workpiece transfer device according to the present disclosure;

FIG. 2 is a front view showing the transfer carrier of the workpiece transfer device according to the present disclosure;

FIG. 3 is an enlarged view showing a top spacer of the workpiece transfer device according to the present disclosure;

FIGS. 4A and 4B are side views showing states where a workpiece is loaded and unloaded in and from the workpiece transfer device according to the present disclosure;

FIGS. 5A and 5B are side views showing a lift pin and a robot pushing piece in the workpiece transfer device according to the present disclosure;

FIG. 6 is a perspective view showing a cart unit of the workpiece transfer device according to the present disclosure;

FIG. 7 is a perspective view showing a lifting loader of the workpiece transfer device according to the present disclosure;

FIG. 8 is a perspective view showing a state where the transfer carrier is loaded onto the lifting loader of the workpiece transfer device according to the present disclosure;

FIG. 9 is a perspective view showing a state where the transfer carrier is lifted by means of the lifting loader in the workpiece transfer device according to the present disclosure;

FIGS. 10A to 10D are photographs showing a loading conveyor of the workpiece transfer device according to the present disclosure;

FIGS. 11A to 11D are photographs showing a state where the transfer carrier is loaded onto a process conveyor by means of the loading conveyor in the workpiece transfer device according to the present disclosure; and

FIGS. 12A to 12C are side views showing a state where carrier hooks are mounted onto the process conveyor in the workpiece transfer device according to the present disclosure.

### DETAILED DESCRIPTION OF THE PREFERRED EMBODIMENT

Hereinafter, an embodiment of the present disclosure will be explained in detail with reference to the attached drawings.

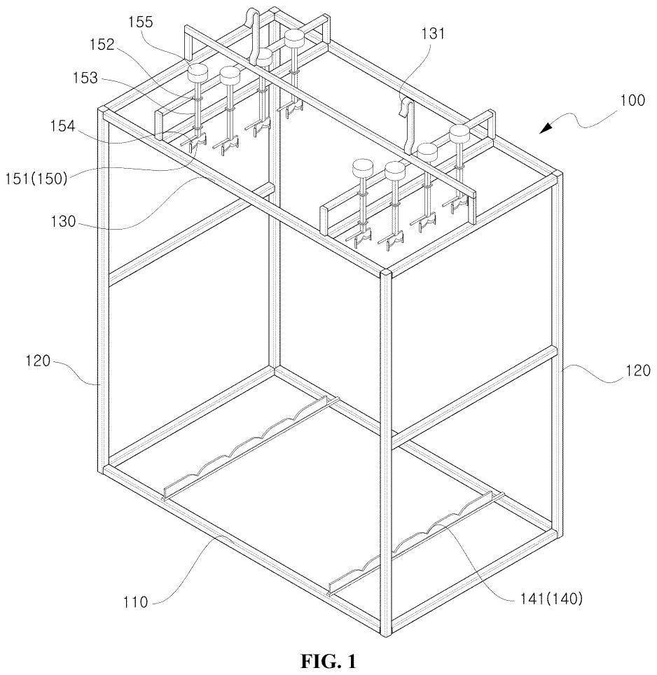

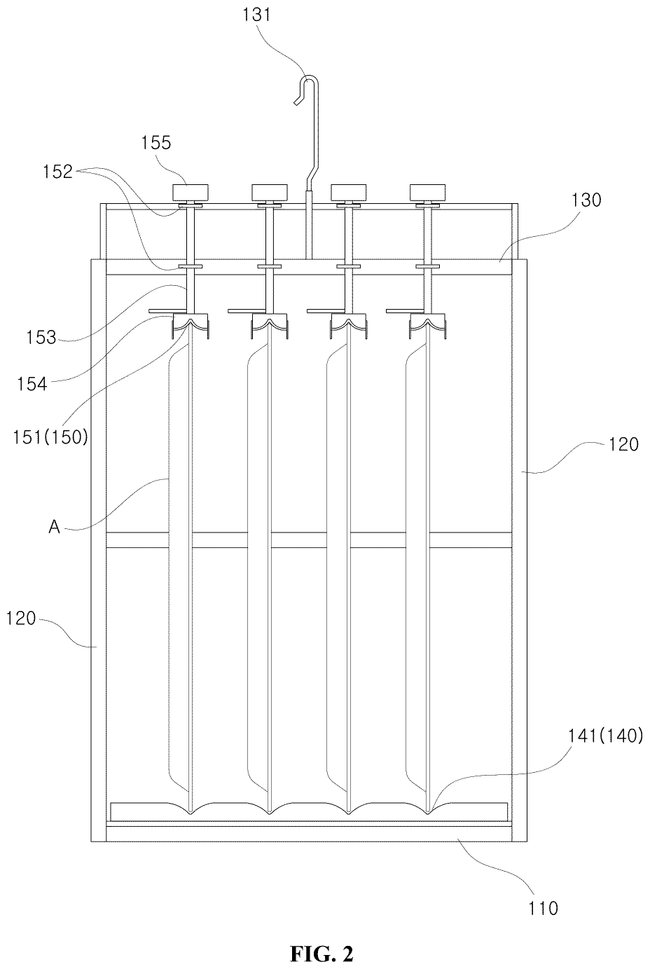

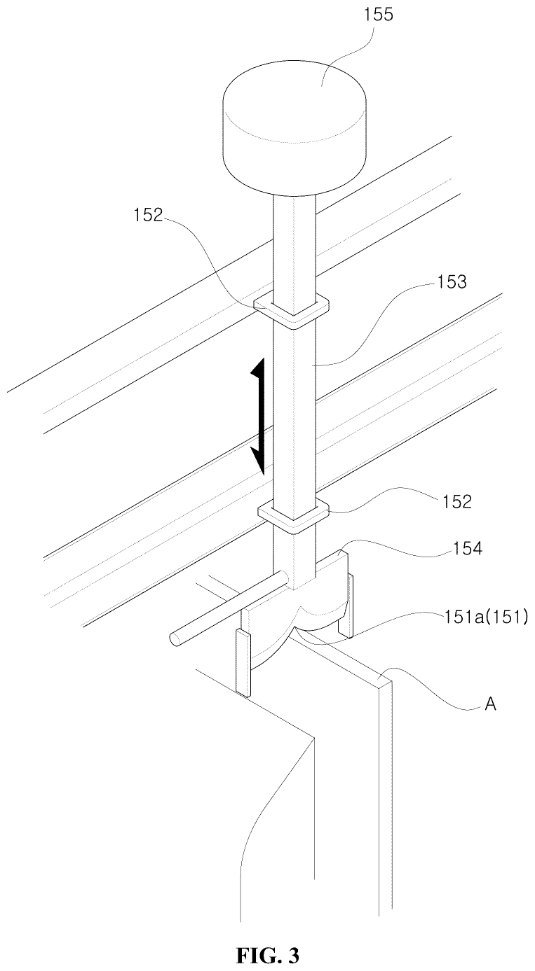

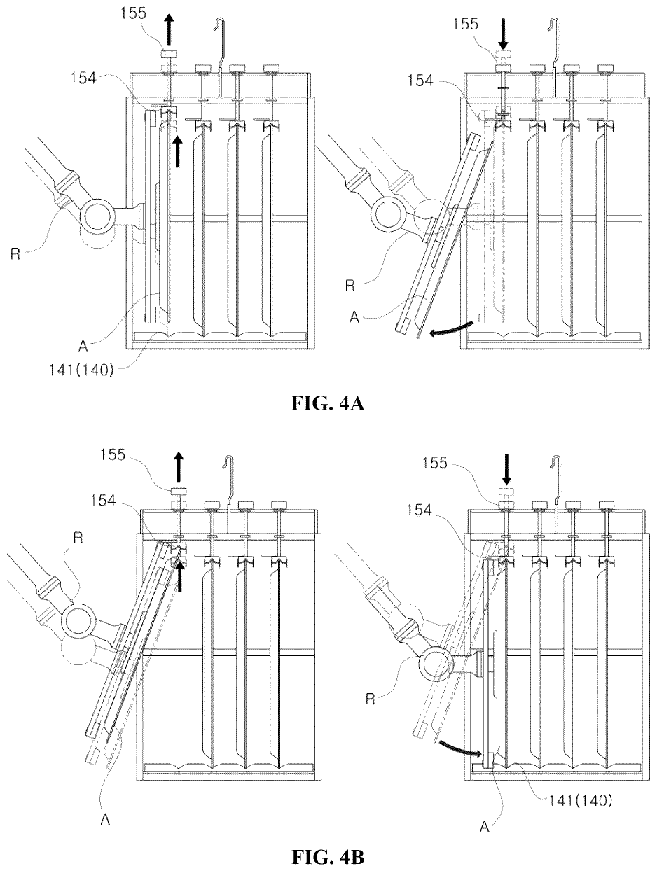

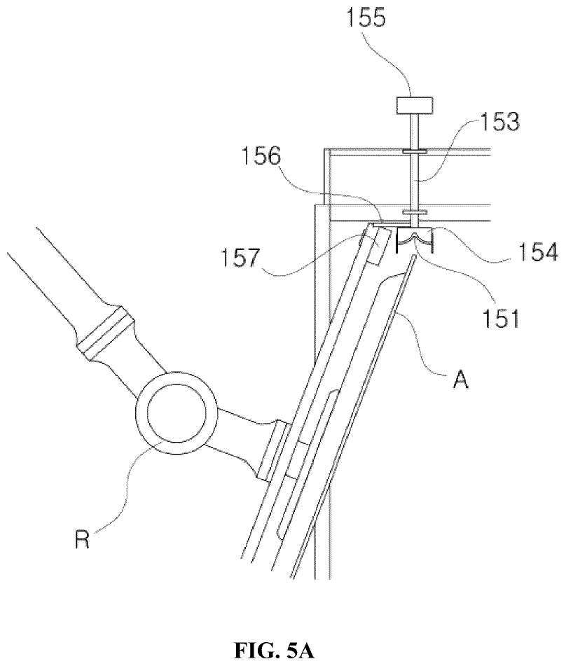

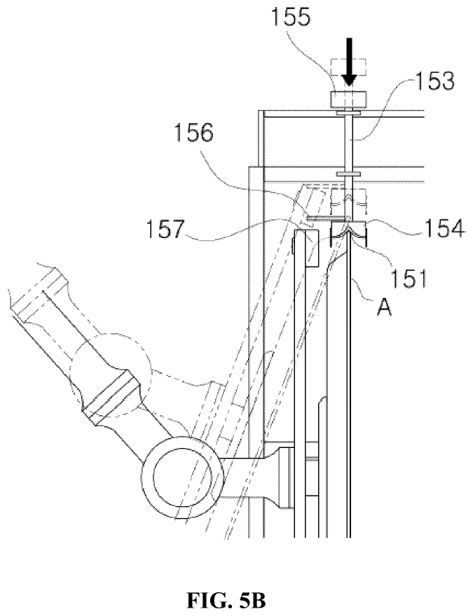

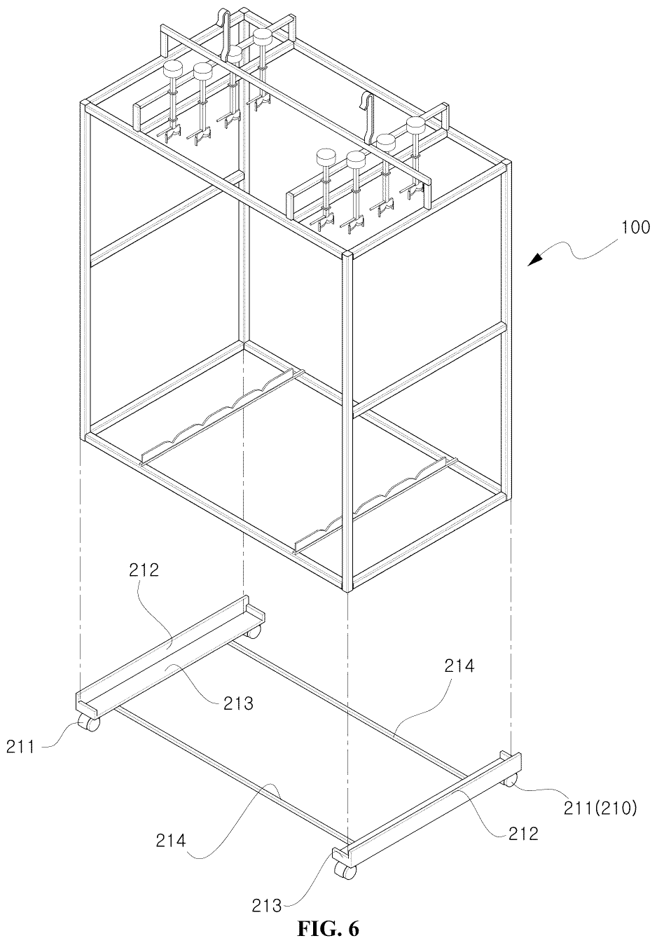

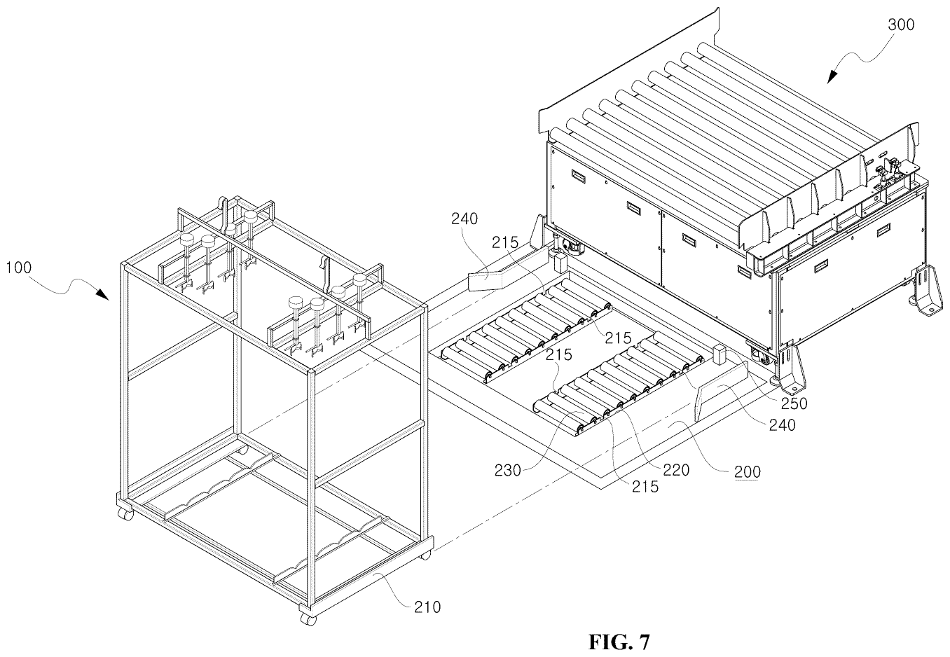

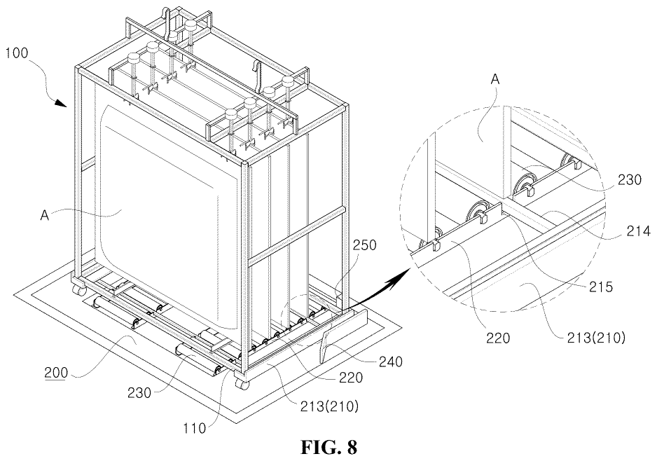

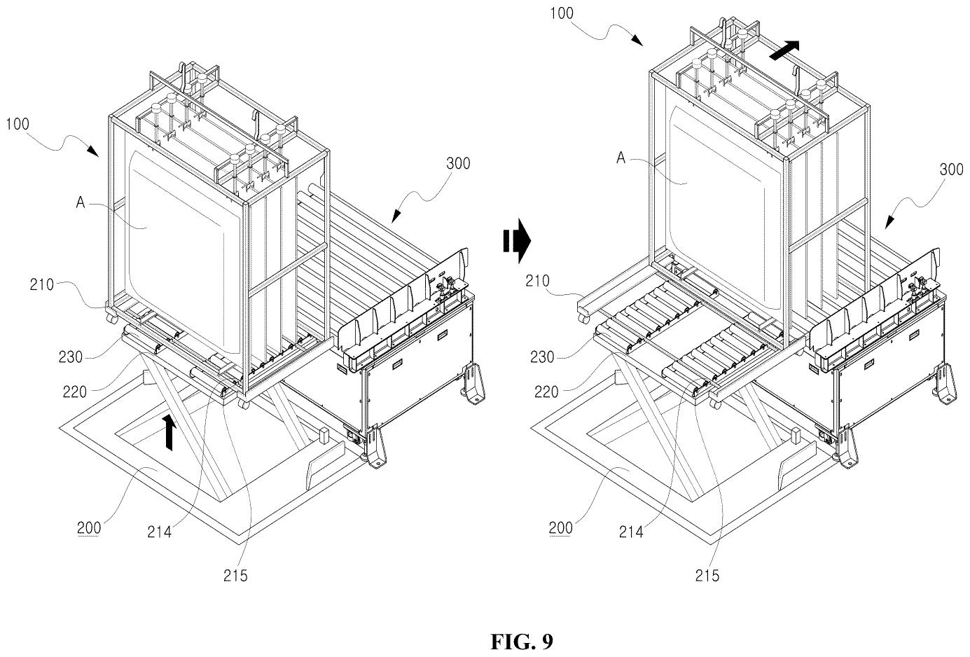

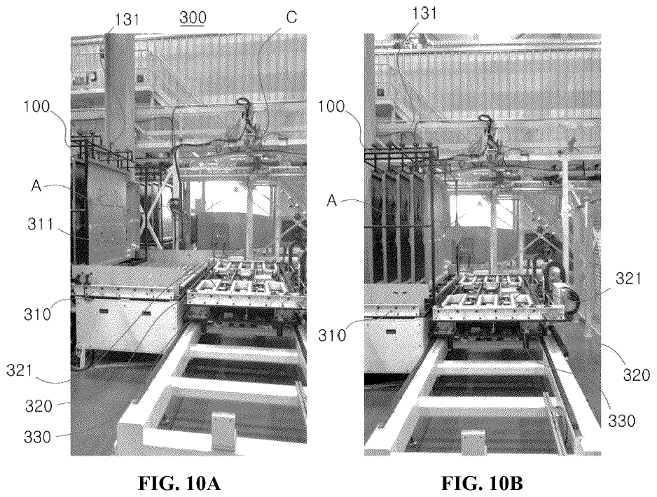

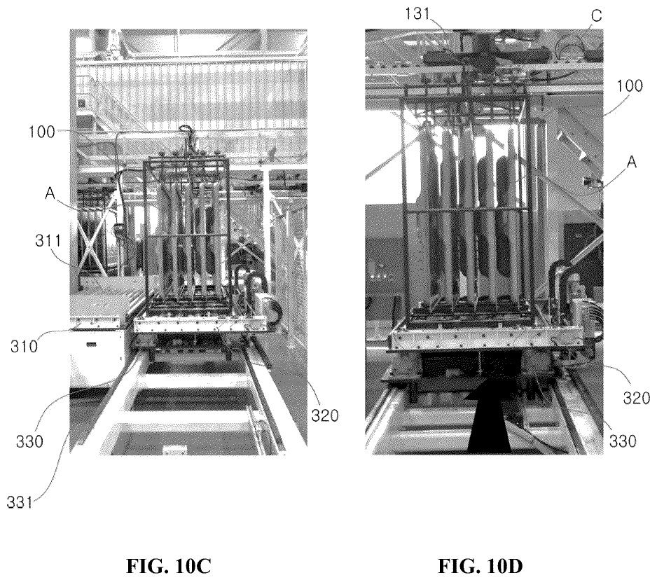

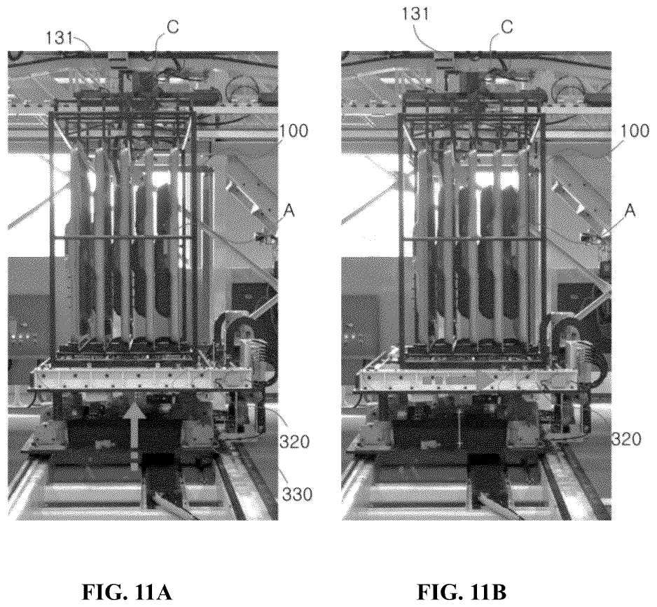

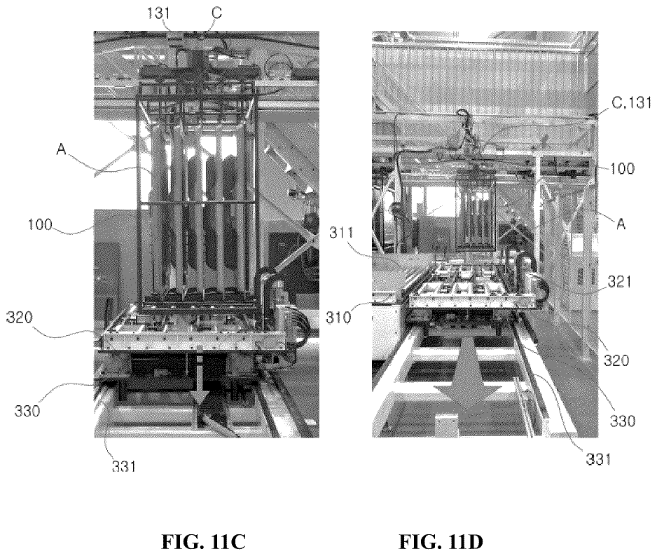

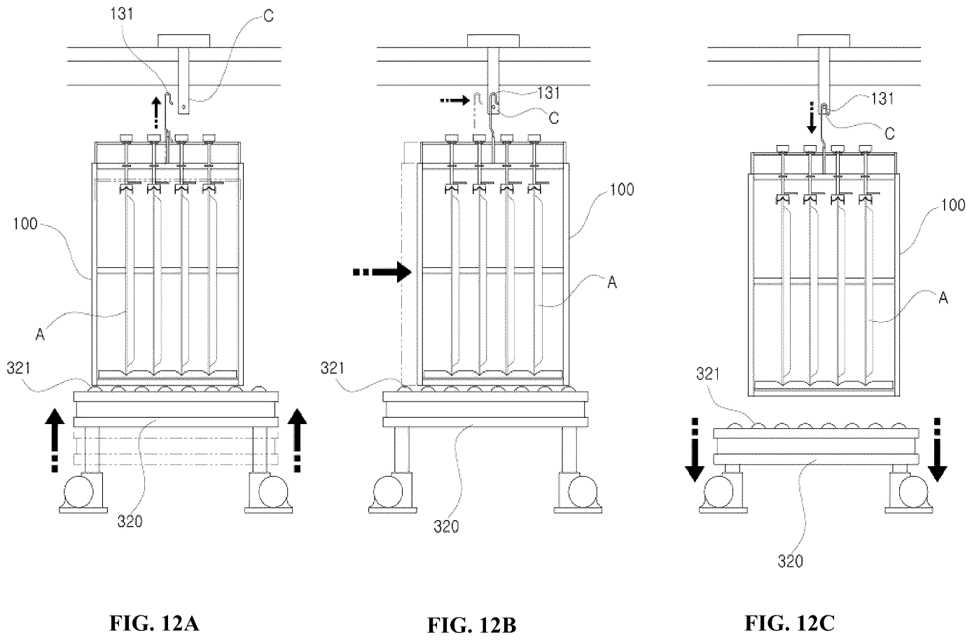

FIG. 1 is a perspective view showing a transfer carrier of a workpiece transfer device according to the present disclosure, FIG. 2 is a front view showing the transfer carrier of the workpiece transfer device according to the present disclosure, FIG. 3 is an enlarged view showing a top spacer of the workpiece transfer device according to the present disclosure, FIGS. 4A and 4B are side views showing states where a workpiece is loaded and unloaded in and from the workpiece transfer device according to the present disclosure, FIGS. 5A and 5B are side views showing a lift pin and a robot pushing piece in the workpiece transfer device according to the present disclosure, FIG. 6 is a perspective view showing a cart unit of the workpiece transfer device according to the present disclosure, FIG. 7 is a perspective view showing a lifting loader of the workpiece transfer device according to the present disclosure, FIG. 8 is a perspective view showing a state where the transfer carrier is loaded onto the lifting loader of the workpiece transfer device according to the present disclosure, FIG. 9 is a perspective view showing a state where the transfer carrier is lifted by means of the lifting loader in the workpiece transfer device according to the present disclosure, FIGS. 10A to 10D are photographs showing a loading conveyor of the workpiece transfer device according to the present disclosure, FIGS. 11A to 11D are photographs showing a state where the transfer carrier is loaded onto a process conveyor by means of the loading conveyor in the workpiece transfer device according to the present disclosure, and FIGS. 12A to 12C are side views showing a state where carrier hooks are mounted onto the process conveyor in the workpiece transfer device according to the present disclosure.

The present disclosure relates to a workpiece transfer device, and the workpiece transfer device largely includes a transfer carrier 100, top spacers 140, and bottom spacers 150 so that the top spacers receive downward pressing forces from weights in a direction of gravity, and only through an upward motion of a robot arm, therefore, a distance between the top spacers and the bottom spacers is expanded and contracted to clamp and unclamp a workpiece, thereby achieving automation in the processes of loading and unloading the workpiece in and from the transfer carrier by means of the robot arm.

The transfer carrier 100 includes a bottom frame 110, side frames 120, and a top frame 130.

The bottom frame 110 is provided in the form of a rectangular frame by connecting horizontal bars and vertical bars arranged in a transverse direction.

The side frames 120 are erected on both sides of the bottom frame 110.

One pair of side frames 120 is facingly arranged, and lower end portions of the side frames 120 are connected to both side corners of the bottom frame 110.

The top frame 130 is located on tops of the side frames 120 and has carrier hooks 131.

The top frame 130 is arranged in parallel to the bottom frame 110, and a plurality of plate-shaped workpieces A are erectedly received in a space between the top frame 130 and the bottom frame 110.

According to the present disclosure, further, the bottom spacers 140 are located on the bottom frame 110, and each bottom spacer 140 has a plurality of bottom jig grooves 141 adapted to receive the undersides of the workpieces A erectedly placed in the transfer carrier 100 therein.

In this case, one pair of bottom spacers 140 is spaced apart from each other in a longitudinal direction of the bottom frame 110, and the plurality of bottom jig grooves 141 are formed on tops of the bottom spacers 140 in a transverse direction of the bottom frame 110.

The workpieces A, which are erected in the transfer carrier 100, are received in the bottom jig grooves 141 of the bottom spacers 140 in such a way as to be spaced apart from one another at given intervals.

According to the present disclosure, further, the top spacers 150 are spaced apart from one another on the top frame 130 in such a way as to correspond to the bottom jig grooves 141, are movable in a longitudinal direction, and each have a top jig groove 151 adapted to receive the top of the corresponding workpieces A therein.

In this case, a plurality of pairs of top spacers 150 are spaced apart from one another in a longitudinal direction of the top frame 130, and each top spacer 150 has the top jig groove 151 in a transverse direction of the top frame 130.

As shown in FIG. 3, each top spacer 150 includes sleeves 152 mounted on the top frame 130, a rod 153 inserted into the sleeves 152 in such a way as to linearly move in a longitudinal direction, a top jaw 154 located on the underside of the rod 153 and having the top jig groove 151 on the underside thereof, and a weight 155 located on top of the rod 153 in such a way as to press the rod 153 downward.

A downward transfer force of the rod 153 is generated due to the self-weight of the weight 155, and together with the rod 153, the top jaw 154 moves downward to restrain the top of the workpiece A thereby.

As the rod 153 is pressed against the weight 155, further, a downward pressing force is consistently generated within the movable range in the longitudinal direction thereof.

If the workpiece A is loaded and unloaded by means of a robot arm R, the top jaws 154 move upward according to the operation of the robot arm R so that downward repulsive forces applied to the top jaws 154 by the weights 155 are consistently maintained to minimize frictional resistance between the workpiece A and the top jaws 154 and prevent the workpiece A from being damaged due to the repulsive forces of the top jaws 154.

The workpiece A that is loaded in the space between the top spacers 150 and the bottom spacers 140 is restrained by the top jig grooves 151 of the top jaws 154 that move downward by means of the weights 155.

If the workpiece A restrained in the space between the top spacers 150 and the bottom spacers 140 moves upward, further, the top jaws 154 move upward together with the workpiece A to allow the workpiece to be released from the restrained state.

Further, the bottom jig grooves 141 and the top jig grooves 151 are V-shaped grooves.

If the workpiece A is restrained by the top spacers 150 and the bottom spacers 140, top and underside of the workpiece A are corrected in position to the centers of the V-shaped grooves as the bottom jig grooves 141 and the top jig grooves 151.

If the workpiece A restrained by the top spacers 150 and the bottom spacers 140 is automatically unloaded by means of the robot arm R, as a result, the workpiece A is clamped accurately by the robot arm R.

As shown in FIG. 3, the top jig groove 151 has a grasping edge 151a on the inner peripheral surface thereof.

The grasping edge 151a has the shape of a blade so that it grasps top of the workpiece A.

If the top jaws 154 of the top spacers 150 move downward to receive the workpiece A into the top jig grooves 151, the grasping edges 151a grasp top of the workpiece A in a perpendicular direction to the workpiece A to prevent the workpiece A from moving in a transverse direction.

In the case where the transfer carrier 100 in which the workpieces A are placed moves, as a result, the workpieces A are firmly restrained at their initial position when loaded in the transfer carrier 100, so that in the process of unloading the workpieces A from the transfer carrier 100 by means of the robot arm R, advantageously, the workpieces A are clamped in their right position.

Referring to a process of unloading the workpiece A from the transfer carrier 100 by means of the robot arm R, as shown in FIG. 4A, the workpiece A placed in the transfer carrier 100 is clamped by a suction pad of the robot arm R and thus unloaded from the transfer carrier 100.

In a state where the suction pad of the robot arm R is sucked onto one side surface of the workpiece A, if the workpiece A moves upward together with the top jaws 154 by means of the robot arm R, the underside of the workpiece A becomes separated from the bottom jig grooves 141.

Next, the workpiece A becomes inclined at a given angle by means of the robot arm R so that the underside of the workpiece A is separated from the bottom jig grooves 141 to the outside.

If the workpiece A moves downward by means of the robot arm R, the top of the workpiece A is separated from the top jig grooves 151 to the outside so that the workpiece A is unloaded from the transfer carrier 100 to the outside.

Referring to a process of loading the workpiece A in the transfer carrier 100 by means of the robot arm R, as shown in FIG. 4B, the workpiece A is clamped by the suction pad of the robot arm R and thus loaded in the transfer carrier 100.

In this case, the suction pad of the robot arm R is sucked onto one side surface of the workpiece A, and in a state where the workpiece A is inclined at a given angle, next, it is put into the space between the top spacers 150 and the bottom spacers 140.

After that, in a state where the top of the workpiece A is received in the top jig grooves 151 by means of the robot arm R, the workpiece A moves upward together with the top jaws 154, and if the workpiece A is corrected perpendicularly in position and then moves downward by means of the robot arm R, next, the underside of the workpiece A is received in the bottom jig grooves 141 and restrained thereby.

As the top spacers 150 move in the longitudinal direction, like this, downward pressing forces are generated by means of the weights 155 in a direction of gravity, so that only through the upward motion of the robot arm R, a distance between the top spacers 150 and the bottom spacers 140 is expanded and contracted to clamp and unclamp the workpiece A, thereby achieving automation in the processes of loading and unloading the workpiece A in and from the transfer carrier 100 by means of the robot arm R.

As shown in FIGS. 5A and 5B, a lift pin 156 is located on one side of the rod 153 or top jaw 154, and the robot arm R has a robot pushing piece 157 at a position corresponding to the lift pin 156.

If it is desired to load the workpiece A in the transfer carrier 100, the workpiece A is clamped by the robot arm R and loaded in the transfer carrier 100, and next, if the workpiece A moves upward at a position corresponding to the top spacers 150 and the bottom spacers 140, the lift pins 156 are pressed against the robot pushing pieces 157 to allow the top jaws 154 to move upward so that the top jig grooves 151 and the workpiece A are kept separated from each other.

If the workpiece A is corrected perpendicularly in position and then moves downward by means of the robot arm R, next, the underside of the workpiece A is received in the bottom jig grooves 141, and after that, the upward pressing forces of the robot pushing pieces 157 against the lift pins 156 are released to allow the top jaws 154 to move downward so that the workpiece A is restrained by the top jig grooves 151.

Like this, the top jaws 154 move upward according to the upward movement of the robot arm R through the lift pins 156 and the robot pushing pieces 157 to allow the top jig grooves 151 and the workpiece A to be separated from each other, so that in the process of loading the workpiece A in the transfer carrier 100, the workpiece A is prevented from being damaged due to its friction against the top jaws 154.

Further, the transfer carrier 100 is lifted by means of the lifting loader 200, moves along a loading conveyor 300, and is then transferred to a process line.

The lifting loader 200 includes a cart unit 210, a lift unit 220, transfer rollers 230, side rails 240, and parking stoppers 250.

According to the present disclosure, the cart unit 210 supports the underside of the transfer carrier 100 thereagainst and has a plurality of casters 211.

As shown in FIG. 6, the cart unit 210 consists of the casters 211, a pair of base arms 213 having locking projections 212 adapted to receive the underside of the transfer carrier 100, and transverse bars 214 for connecting the base arms 213 to each other.

Each locking projection 212 is formed of a ‘└’-shaped bracket in plane, and the locking projections 212 are placed in position in such a way as to correspond to the four corners of the underside of the transfer carrier 100 to restrain the transfer carrier 100 seated onto the cart unit 210 thereby.

One pair of transverse bars 214 is arranged parallel to each other, and the base arms 213 are connected to both ends of the transverse bars 214.

If the transfer carrier 100 is lifted by means of the lift unit 220, the transverse bars 214 are received between the transfer rollers 230 of the lift unit 220, and to allow the transverse bars 214 received between the transfer rollers 230 of the lift unit 220 to be restrained, stop grooves 215 are formed on top of the lift unit 220.

If it is desired to lift the transfer carrier 100 by means of the lift unit 220, as shown in FIG. 8, the transverse bars 214 are received in the stop grooves 215 to allow the cart unit 210 to be fixed (restrained) in position, and as the transfer carrier 100 mounted onto the cart unit 210 is lifted in a state of being supported against the transfer rollers 230, next, the underside of the transfer carrier 100 is separated from the locking projections 210. After that, the transfer carrier 100 moves along the transfer rollers 230 and is thus transferred to the loading conveyor 300.

According to the present disclosure, as shown in FIG. 7, the lift unit 220 is buried in a floor at the entrance of the loading conveyor 300 and thus lifts the transfer carrier 100 mounted onto the cart unit 210 to allow the bottom frame 110 of the transfer carrier 100 to be placed on the same horizontal line as the loading conveyor 300.

The lift unit 220 is movable in the longitudinal direction by means of a driving part such as a hydraulic cylinder.

If the lift unit 220 moves downward, as shown in FIG. 8, top of the lift unit 220 is placed on the same horizontal line as the floor to allow the transfer carrier 100 and the cart unit 210 moving along the floor to be facingly located on top of the lift unit 220.

Next, if the lift unit 220 moves upward, as shown in FIG. 9, the bottom frame 110 of the transfer carrier 100 moves to a height corresponding to the same horizontal line as the loading conveyor 300 so that the transfer carrier 100 is transferred to the loading conveyor 300 along the transfer rollers 230 as will be discussed later.

According to the present disclosure, the transfer rollers 230 are located on top of the lift unit 220 to support the underside of the transfer carrier 100 mounted onto the cart unit 210 thereagainst.

If the lift unit 220 moves upward, the transfer rollers 230 move to the height corresponding to the same horizontal line as the loading conveyor 300 to allow the transfer carrier 100 mounted on the lift unit 220 to be transferred to the loading conveyor 300.

According to the present disclosure, further, the side rails 240 are located on the floor in such a way as to correspond to both sides of the lift unit 220 in the transverse direction of the lift unit 220 and thus serve to guide the cart unit 210 to allow the cart unit 210 to move to an area corresponding to top of the lift unit 220.

One pair of side rails 240 is facingly arranged, and slant rails extend from one side end portion of the pair of side rails 240, along which the transfer carrier 100 moves, so that the transfer carrier 100 and the cart unit 210 are induced to move to the inside of the pair of side rails 240.

According to the present disclosure, further, the parking stoppers 250 serve to restrict a moving distance of the cart unit 210 moving to the lift unit 220 along the side rails 240.

The parking stoppers 250 are located on the floor and have buffering pads such as rubber pads on one surface thereof to absorb the impact generated when the cart unit 210 collides with the transfer carrier 100.

Like this, a structural improvement is made so that the transfer carrier 100 is lifted and transferred to the loading conveyor 300 by means of the lifting loader 200, and without any heavy equipment such as a crane, therefore, the transfer carrier 100 in which the workpieces A are placed is automatically loaded. In this case, above all, the transfer carrier 100 and the cart unit 210 are joined together in such a way as to allow the cart unit 210 to be automatically separated from the transfer carrier 100, while the transfer carrier 100 is being lifted by means of the lifting loader 200, thereby advantageously achieving the lightweight and compactness of the transfer carrier 100.

As shown in FIGS. 10A to 10D, the loading conveyor 300 includes a roller conveyor 310 having a plurality of first feeding rollers 311 adapted to transfer the transfer carrier 100 received from the lifting loader 200, a movable conveyor 320 located on the end portion of the roller conveyor 310 and having a plurality of second feeding rollers 321 on top thereof to mount the transfer carrier 100 thereon, and a transfer shuttle 330 transferred to the process line along transfer rails 331, while supporting the movable conveyor 320 to allow the movable conveyor 320 to be movable up and down.

In this case, the process line has a process conveyor C such as a chain conveyor, and the carrier hooks 131 of the transfer carrier 100 are locked onto transfer hooks moving engagingly with the process conveyor C.

Further, the roller conveyor 310 and the movable conveyor 320 are arranged in transfer directions crossing each other, as shown FIGS. 10A to 10D, but without being limited thereto, they may be arranged in a transfer direction of a straight line or in transfer directions coming into contact with each other at a given angle.

Referring to the transfer state of the transfer carrier 100 through the loading conveyor 300, the transfer carrier 100 is transferred along the first feeding rollers 311 of the roller conveyor 310 and then mounted on the movable conveyor 320 along the second feeding rollers 321. In this case, the transfer carrier 100 mounted on the movable conveyor 320 is restrained by means of clamps.

After that, if the transfer carrier 100 moves to an area under the process conveyor C of the process line, together with the movable carrier 320, by means of the transfer shuttle 330, as shown in FIGS. 11A and 12A, the transfer carrier 100 moves upward together with the movable conveyor 320 by means of the transfer shuttle 330, and if the transfer carrier 100 moves in the longitudinal direction of the process conveyor C by means of the second feeding rollers 321, as shown in FIGS. 11B and 12B, the carrier hooks 131 mounted on top of the transfer carrier 100 are mounted on the process conveyor C.

After that, as shown in FIGS. 11C and 12C, the movable conveyor 320 moves downward by means of the transfer shuttle 330 and returns to a position corresponding to the roller conveyor 310 along the transfer rails 331.

Like this, the transfer carrier 100 is automatically transferred and mounted on the process conveyor C by means of the loading conveyor 300, so that advantageously, unmanned automation in the transfer process of the workpiece A is carried out.

As described above, the workpiece transfer device of the present disclosure is configured to allow the top spacers to receive the downward pressing forces from the weights in a direction of gravity so that only through the upward motion of the robot arm, a distance between the top spacers and bottom spacers is expanded and contracted to clamp and unclamp the workpiece, thereby achieving automation in the processes of loading and unloading the workpiece in and from the transfer carrier by means of the robot arm.

While the present disclosure has been made with reference to the particular illustrative embodiments, it is not to be restricted by the embodiments but only by the appended claims. It is to be appreciated that those skilled in the art can change or modify the embodiments without departing from the scope and spirit of the present disclosure.

1. A workpiece transfer device comprising:
a transfer carrier (100) having a bottom frame (110), side frames (120) erected on both sides of the bottom frame (110), and a top frame (130) located on tops of the side frames (120) and having carrier hooks (131);
bottom spacers (140) located on the bottom frame (110) and each having a plurality of bottom jig grooves (141) adapted to receive the undersides of workpieces (A) therein, the workpieces (A) being erectedly placed in the transfer carrier (100); and
top spacers (150) spaced apart from one another on the top frame (130) in such a way as to correspond to the bottom jig grooves (141), movable in a longitudinal direction thereof, and each having a top jig groove (151) adapted to receive the top of the corresponding workpiece (A) therein,
wherein each top spacer (150) comprises sleeves (152) mounted on the top frame (130), a rod (153) inserted into the sleeves (152) in such a way as to linearly move in a longitudinal direction, a top jaw (154) located on the underside of the rod (153) and having the top jig groove (151) on the underside thereof, and a weight (155) located on top of the rod (153) in such a way as to press the rod (153) downward.

2. The workpiece transfer device according to claim 1, wherein the bottom jig grooves (141) and the top jig grooves (151) are V-shaped grooves, and if the workpieces (A) are restrained by the top spacers (150) and the bottom spacers (140), tops and undersides of the workpieces (A) are corrected in position to the centers of the V-shaped grooves as the bottom jig grooves (141) and the top jig grooves (151).

3. The workpiece transfer device according to claim 2, wherein each top jig groove (151) has a grasping edge (151a) on the inner peripheral surface thereof in such a way as to grasp top of the workpiece (A) and thus restrain the workpiece (A) thereby.

4. The workpiece transfer device according to claim 1, wherein the workpiece (A) placed in the transfer carrier (100) is clamped by a suction pad of a robot arm (R), and in a state where the suction pad of the robot arm (R) is sucked onto one side surface of the workpiece (A), if the workpiece (A) moves upward together with the top jaws (154) by means of the robot arm (R), the underside of the workpiece (A) becomes separated from the bottom jig grooves (141) and is then inclined at a given angle by means of the robot arm (R), so that the underside of the workpiece (A) is separated from the bottom jig grooves (141) to the outside, and next, if the workpiece (A) moves downward by means of the robot arm (R), the top of the workpiece (A) is separated from the top jig grooves (151) to the outside to allow the workpiece (A) to be unloaded from the transfer carrier (100).

5. The workpiece transfer device according to claim 1, wherein the workpiece (A) is clamped by the suction pad of the robot arm (R), and in the state where the suction pad of the robot arm (R) is sucked onto one side surface of the workpiece (A), the workpiece (A) is inclined at a given angle, put between the top spacers (150) and the bottom spacers (140), and moves upward together with the top jaws (154) in a state where the top of the workpiece (A) is received in the top jig grooves (151) by means of the robot arm (R), so that if the workpiece (A) is corrected perpendicularly in position and then moves downward by means of the robot arm (R), the underside of the workpiece (A) is received in the bottom jig grooves (141) and restrained thereby.

6. The workpiece transfer device according to claim 1, wherein the rod (153) or the top jaw (154) has a lift pin (156) on one side thereof, and the robot arm (R) has a robot pushing piece (157) at a position corresponding to the lift pin (156), so that to load the workpiece (A) in the transfer carrier (100), if the workpiece (A) is clamped by the robot arm (R), is inserted into the transfer carrier (100), and thus moves upward at positions corresponding to the top spacers (150) and the bottom spacers (140), the lift pins (156) are pressed against the robot pushing pieces (157) to allow the top jaws (154) to move upward, which causes the top jig grooves (151) and the workpiece (A) to be kept separated from each other, and if the workpiece (A) is corrected perpendicularly in position and then moves downward by means of the robot arm (R), next, the underside of the workpiece (A) is received in the bottom jig grooves (141) to allow the upward pressing forces of the robot pushing pieces (157) against the lift pins (156) to be released, which causes the workpiece (A) to be restrained by the top jig grooves (151) through the downward movement of the top jaws (154).

7. The workpiece transfer device according to claim 1, wherein the transfer carrier (100) is lifted by means of a lifting loader (200), moves along a loading conveyor (300), and is transferred to a process line, and the lifting loader (200) comprises:
a cart unit (210) adapted to support the underside of the transfer carrier (100) thereagainst and having a plurality of casters (211);
a lift unit (220) buried in a floor at the entrance of the loading conveyor (300) in such a way as to lift the transfer carrier (100) mounted onto the cart unit (210) to allow the bottom frame (110) of the transfer carrier (100) to be placed on the same horizontal line as the loading conveyor (300);
transfer rollers (230) located on top of the lift unit (220) in such a way as to support the underside of the transfer carrier (100) mounted onto the cart unit (210);
side rails (240) located on the floor in such a way as to correspond to both sides of the lift unit (220) in the transverse direction of the lift unit (220) in such a way as to guide the cart unit (210) to allow the cart unit (210) to move to an area corresponding to top of the lift unit (220); and
parking stoppers (250) located on the floor in such a way as to restrict a moving distance of the cart unit (210) moving to the lift unit (220) along the side rails (240).

8. The workpiece transfer device according to claim 7, wherein the loading conveyor (300) comprises:
a roller conveyor (310) having a plurality of first feeding rollers (311) adapted to transfer the transfer carrier (100) received from the lifting loader (200);
a movable conveyor (320) located on the end portion of the roller conveyor (310) and having a plurality of second feeding rollers (321) on top thereof to mount the transfer carrier (100) thereon; and
a transfer shuttle (330) transferred to the process line along transfer rails (331), while supporting the movable conveyor (320) to allow the movable conveyor (320) to be movable up and down.

9. The workpiece transfer device according to claim 8, wherein the transfer carrier (100) is transferred along the first feeding rollers (311) of the roller conveyor (310) and then mounted on the movable conveyor (320) along the second feeding rollers (321), so that if the transfer carrier (100) moves to an area under a process conveyor (C) of the process line, together with the movable carrier (320), by means of the transfer shuttle (330), the transfer carrier (100) moves upward together with the movable conveyor (320) by means of the transfer shuttle (330), and if the transfer carrier (100) moves in the longitudinal direction of the process conveyor (C) by means of the second feeding rollers (321), the carrier hooks (131) mounted on top of the transfer carrier (100) are mounted on the process conveyor (C) to allow the movable conveyor (320) to move downward by means of the transfer shuttle (330) and thus return to a position corresponding to the roller conveyor (310) along the transfer rails (331).
